(19) United States
(12) Patent Application Publication
(10) Pub. No.: US 2024/0135322 A1
(43) Pub. Date: Apr. 25, 2024

(54) STRUCTURED ANALYSIS RELATING TO DEADLINE DRIVEN PROJECT MANAGEMENT

(71) Applicant: Black Hills IP Holdings, LLC, Minneapolis, MN (US)

(72) Inventors: Steven W. Lundberg, Edina, MN (US); Russell D. Slifer, Boise, ID (US)

(21) Appl. No.: 18/351,425

(22) Filed: Jul. 11, 2023

Related U.S. Application Data
(60) Provisional application No. 63/419,215, filed on Oct. 25, 2022.

(51) Int. Cl. G06Q 10/10; G06Q 50/18

(52) U.S. Cl. CPC G06Q 10/10; G06Q 50/184

(57) ABSTRACT

Various embodiments disclosed relate to a method of structured analysis management using a data drive software tool. The present disclosure includes a computer implemented patent prosecution workflow management method including: receiving an indication of a dataset to be transformed; analyzing the dataset with a structured analysis tool to determine state data contained in the dataset, wherein the dataset represents one or more states of a process; using the determined state data of the dataset to display a plurality of information on a user interface related to the state data; determining and displaying one or more unexpected states of the process, wherein unexpected states comprise an anomaly with respect to various components of the dataset; providing one or more options for response based on the state data; providing a probability of success for each of the one or more options for response; providing a recommendation of which of the one or more options to select; providing one or more pending requirements for the dataset, each of the one or more options for response correlating to the one or more pending requirements; receiving an indication of a selection of the one or more options for response; and providing a document for the response for user interaction.

### CLAIM OF PRIORITY

This application claims the benefit of priority under 35 U.S.C. § 119(e) to U.S. Provisional Patent Application Ser. No. 63/419,215, filed on Oct. 25, 2022, and which is incorporated by reference herein in its entirety.

### TECHNICAL FIELD

The application is directed toward an electronic docketing system and, more specifically, to an electronic docketing system that provides structured analysis relating to deadlines.

### BACKGROUND

In a business, docketing systems may be used to track workflow deadlines, tasks, and progress. For example, in a given project, a docketing system may track when the project is opened, what initial filings are due when, and correspondence coming in regarding that project. The docketing system may additionally be used to record deadlines and flag correspondence or documents that may require a response. However, in a general docketing setting, a large number of items and tasks are incoming and often need to be sorted during docketing. Typically, many deadlines and reminders are created to manage such a system and portfolio.

### SUMMARY OF THE DISCLOSURE

The present disclosure provides methods and systems for workflow management in a patent prosecution context. The discussed methods and approaches leverage a computer, and a data-driven structured analysis tool to provide a patent practitioner with pertinent information regarding a pending patent case, alert the user to any potential unusual aspects of the case, help the user track upcoming actions and requirements, and allow for more easily accessible templates, forms, and documents for responding in patent prosecution cases.

In an example, a computer implemented data display and recommendation method may include: receiving an indication of a dataset to be transformed; analyzing the dataset with a structured analysis tool to determine state data contained in the dataset, wherein the dataset represents one or more states of a process; using the determined state data of the dataset to display a plurality of information on a user interface related to the state data; determining and displaying one or more unexpected states of the process, wherein unexpected states comprise an anomaly with respect to various components of the dataset; providing one or more options for response based on the state data; providing a probability of success for each of the one or more options for response; providing a recommendation of which of the one or more options to select; providing one or more pending requirements for the dataset, each of the one or more options for response correlating to the one or more pending requirements; receiving an indication of a selection of the one or more options for response; and providing a document for the response for user interaction.

In an example, a data display and recommendation system may include: a memory that stores instructions for implementing a structured analysis tool; and one or more processors that execute the instructions for the structured analysis tool to perform operations including: receiving an indication of a dataset to be transformed; analyzing the dataset with the structured analysis tool to determine state data contained in the dataset, wherein the dataset represents one or more states of a process; using the determined state data of the dataset to display a plurality of information on a user interface related to the state data; determining and displaying one or more unexpected states of the process, wherein unexpected states comprise an anomaly with respect to various components of the dataset; providing one or more options for response based on the analyzed state data; providing a probability of success for each of the one or more options for response; providing a recommendation of which of the one or more options to select; providing one or more pending requirements for the dataset, each of the one or more options for response correlating to the one or more pending requirements; and receiving an indication of a selection of the one or more options for response, and; providing a document for the response for user interaction.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 depicts a schematic of an automated patent docketing system in an example.

FIG. 2 depicts third party data sources in an example.

FIG. 3 is a schematic diagram of a docketing system including a structured analysis tool.

FIG. 4 depicts a schematic of a user interface for use with structured analysis tool in an example.

FIG. 5 depicts a schematic of a user interface for use with structured analysis tool in an example.

FIG. 6 depicts a schematic of a user interface for use with structured analysis tool in an example.

FIG. 7 depicts a process of using structured analysis tool in an example.

FIG. 8 depicts a process of using structured analysis tool in an example.

FIG. 9 depicts a process of using structured analysis tool in an example.

FIG. 10 depicts a method of using structured analysis tool in an example.

FIG. 11 depicts a computer system in an example.

### DETAILED DESCRIPTION

The present disclosure describes, among other things, a system and method for deadline driven project management. The method allows for creation and dynamic updating of structured analysis and workflows. For example, the system may receive an office action from the USPTO.

As used herein, “electronic communication” refers to an electronic message or a method of exchanging messages between people using electronic devices.

As used herein, “template” may include a preset format for a document or file, used so that the format does not have to be recreated each time it is used. In some cases, a template may include one or more fields to be filled out.

As used herein, “application” or “program” may include a program or piece of software designed and written to fulfill a particular purpose of the user, such as a database application.

As used herein, “associate” may include a partner or colleague in business or at work, either internal or external.

As used herein, “unstructured text” or “unstructured data” refers to data that is not organized in a standard format, for example, text in the body of an electronic communication.

As used herein, “structured text” or “structured data” refers to data that is organized in a standard format such that a recipient may read the data and institute an automated computing system action without human interpretation of the data.

As used herein, “scraping,” “web scraping”, “data scraping”, or “web crawling” may refer to automatically mining or collecting data or information, such as from a database or from the internet.

As used herein, “file” or “matter” may refer to a particular project, enterprise, or undertaking being worked on by an individual or a collaborative group, planned and designed to achieve a particular aim.

As used herein, “official record” or “file history” may refer to data about a file or matter denoting evidence about past events or tasks within that file or matter, such as an electronic record of previous events in the file or matter. An “official record” may be stored with and maintained by an overseeing agency or organization, such as a governmental organization.

As used herein, “database” may refer to a structured set of data, such as held in a computer or on the internet, that may be accessible in various ways.

As used herein, “deadline” refers to a target completion date. Deadlines may be set internally, externally, by a third party, or by a governmental agency.

As used herein, “reminder” refers to a prompt or message to a user that indicates a task to be completed.

As used herein, “extension” refers to an extension or postponement of a deadline. For example, an extension may be movement of a deadline date to a later time, for the payment of a fee with a governmental entity.

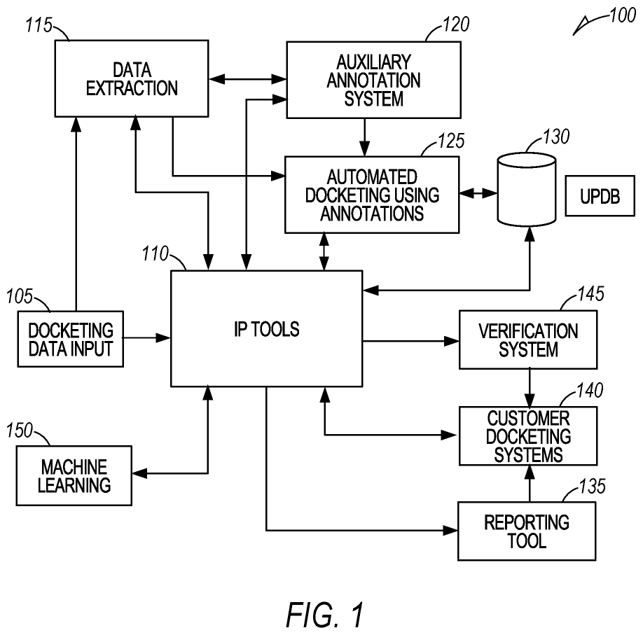

FIG. 1 is a block diagram of a docketing system 100 in an example. The docketing system 100 may be automated or semi-automated. The docketing system 100 may include docketing data input 105, docketing manger 110, data extraction 115, auxiliary annotation system 120, automated docketing using annotations 125, Universal Procedures Database 130, reporting tool 135, customer docketing system 140, verification system 145, and machine learning 150.

The automated docketing system 100 may receive documents from third party sources including third party docketing systems and/or customer data as docketing data input. The docketing manager system 110 may process the received documents to provide to the customer docketing systems 140 and prepare the documents for data extraction by the data extraction system 115 as needed.

The data extraction system 115 may perform Optical Character Recognition (OCR) on the received documents from the docketing manager system 110 to extract data, read checkboxes, extract lists, and identify documents where possible. The docketing manager system 110 may also integrate with a Universal Procedures Database (UPDB) 130 to provide automated docketing by an automated docketing tool 125 that processes received documents based on the additional annotations added to the documents based on the complex data extraction performed by the Auxiliary Annotation System (AAS) 120.

The AAS 120 may further identify the received documents without using an OCR. To manage this process, the docketing manager system 110 may receive frequent updates of docketing procedure rules including configuration data and updates the UPDB 130 with universal procedure codes (UPCs) as appropriate. The UPCs may be used in conjunction with customer specific codes, checklists, and templates. The rules may specify how to fill in the templates and how to complete customer-specific procedures such as how to docket documents into the customer's docketing system 140, for example. The template may be filled out by pulling in attributes from the annotations in a document.

The docketing manager system 110 may receive or intake documents and docketing data from several different sources of docketing data input 105, validate the docketing items against entries in a customer's docketing system 140, and communicate those documents to the customer's docketing system 140 via a unified interface. The docketing manager system 110 may also route documents and associated docketing data through the data extraction system 115 and the AAS 120 and organize the returned metadata and annotations. The docketing manager system 110 thus may provide a breakout between the metadata and the document text.

The docketing manager system 110 may also keep records and communicate with third-party application programming interfaces (APIs) to push the docketing data and documents automatically where allowed. Otherwise, the docketing manager system 110 may present the documents to human docketers to docket. The docketing manager system 110 may also issue reports upon request.

The docketing manager system 110 may be integrated with a customer's existing docketing system (e.g., FOUNDATIONIP®), semi-integrated (e.g., CPI, ANAQUA®, etc.), may provide a virtual host that does not talk at all to the customer's existing docketing system (e.g., IP Manager, MEMOTECH™), or may provide outputs in spreadsheet form for use by a docketing administrator to update the customer's docketing system 140.

If the docketing manager system 110 and the customer's docketing system are not integrated, the data output of automated docketing system 100 may be presented to a human docketer for manual entry. For example, the human docketer may implement macros that interface with the customer's docketing system 140 to populate the received data into the customer's docketing system 140.

On the other hand, if the docketing manager system 110 and the customer's docketing system 140 are integrated or semi-integrated, the data output may be processed to determine if any data is missing to automate the docketing process. If anything is missing, the human docketer may add that information before the automated docketing process may proceed further or the data may be auto-populated and mapped to the template from the UPDB 130.

The automated docketing system 100 may also perform several post-docketing actions, such as sending docketing reports/details to an external verification system 145 that uses a set of rules to verify proper docketing in a host system. The verification system 145 may verify that the data is correctly added to the external customer's docketing system 140. For example, the external verification system 145 may pull data from the AAS 120, the docketing manager system 110, and the customer's docketing system 140 to compare what is present to what is expected to be present in the respective systems.

The automated docketing system 100 may also provide automated “report out” email notifications to customers by implementing a reporting tool 135 that specifies docketing actions based on UPDB template configurations. The reporting tool 135 may also provide completed docketing reports to customers either directly or via the customers' docketing system 140.

In some cases, machine learning techniques may be used to generate annotations. For example, a database of past documents that have been identified may be provided by the docketing manager system 110 and used as a data warehouse to train and improve machine learning models by creating a training set for the machine learning model. Over time, the machine learning model system 150 may learn which PTO IDs to use for which documents, which document in a bundle of documents may be used to characterize the bundle, and may provide predicted PTO IDs for the received documents. The machine learning model system 150 may also establish rule engine prediction capabilities for received documents that test the classifications.

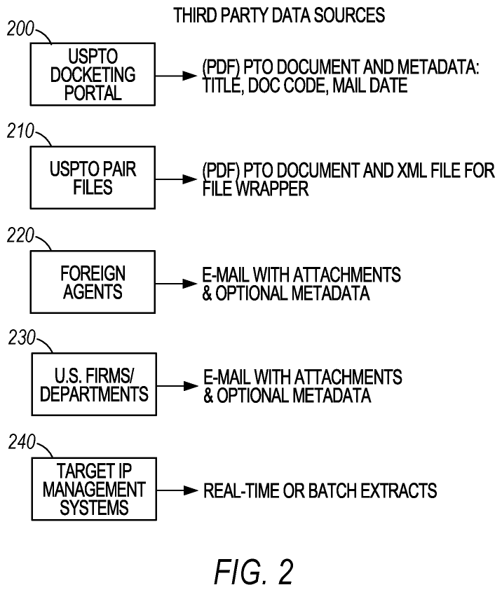

FIG. 2 illustrates sample third-party data sources that provide docketing data input 105 for an automated docketing system 100 implemented for managing patent portfolios in an example. As illustrated in FIG. 2, the third-party data sources may include the Patent Office (e.g., USPTO) docketing portal 200, which provides documents from the USPTO in portable document format (PDF) and includes metadata identifying the title, document code, and mail date for the corresponding document. The third-party data sources may further include USPTO extensible markup language (XML) files 210, which provide documents from the USPTO in PDF and includes an XML file for patent file wrappers. The third-party data sources may also include foreign agents 220 who provide emails with attachments and optional metadata. Foreign agents 220 may also provide hard copy documents that may be scanned for data entry. Similarly, law firms and/or corporate law departments 230 may provide emails with attachments and optional metadata as well as hard copy documents that may be scanned for data entry. Also, third-party docketing systems 240 may provide real-time or batch extracts of data for entry into a docketing management system.

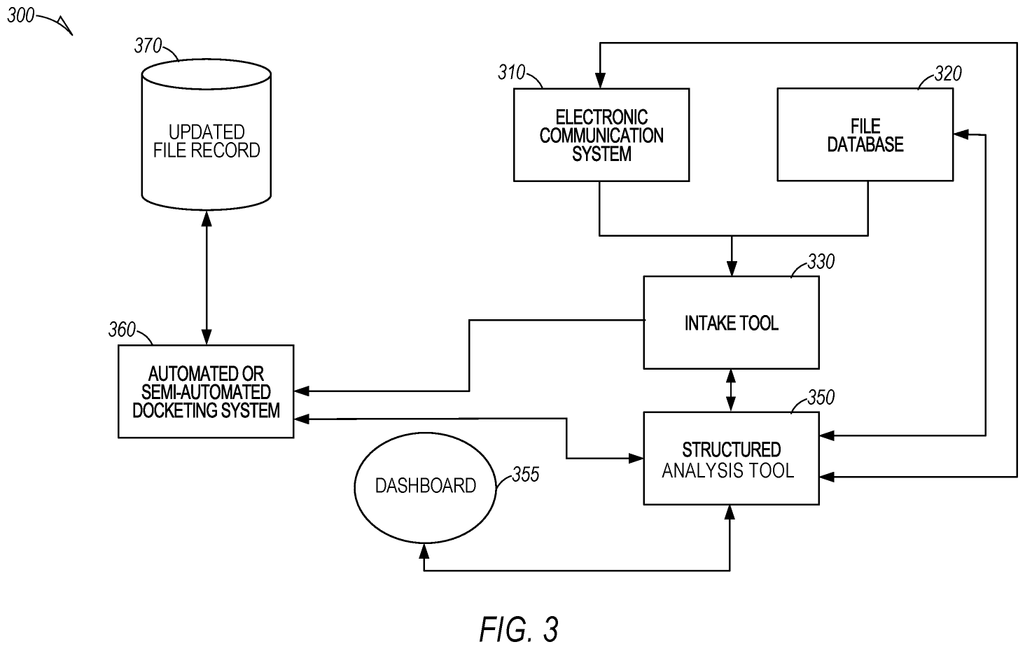

FIG. 3 is a schematic diagram of a docketing system including a structured analysis tool 350. The structured analysis tool 350 may be leveraged to help a user manage workflow of tasks (such as a large docket of tasks), deadlines, and projects, that may be upcoming.

The system 300 may include, for example, an electronic communication system 310, a file database 320, an intake tool 330, the structured analysis tool 350 with a user interface 355, an automated or semi-automated docketing system 360, and file records 370.

The electronic communication system 310 may be, for example, an e-mail, text, audio message, or other means of communicating with internal and external personnel and entities. The electronic communication system 310 may be a user-accessible system for receiving and/or sending messages, such as through a user interface or other computer. The electronic communication system 310 may be, for example, an e-mail server or other communication system.

The file database 320 may include a repository of files or projects being worked on by the company. The file database 320 may be, for example, a public or private database, such as a governmental run database. In an example, the USPTO PAIR database may be accessed. In an example, ESPACENET may be accessed. In some cases, other databases may be used. In some cases, privately run and updated databases may be accessed. The file database 320 may include information on various files of interest for the business. For example, the file database 320 may include information about patent applications or trademark applications. Such information may, for example, include communications from a governmental agency, responses filed by the company, and other official documents.

The intake tool 330 may include a program or application for receiving electronic communications and associated documents or files. In some cases, the intake tool 330 may be configured to manually or automatically receive incoming patent documents or events.

The structured analysis tool 350 may help a user manage a project or case by highlighting and prioritizing tasks which should be completed next. The structured analysis tool 350 may supplement work done by the user, such as by providing templates, filling forms, and cross-checking work.

The structured analysis tool 350 may be used for deadline driven project management. For example, the structured analysis tool 350 may begin by receiving an indication of a project to be worked on. The structured analysis tool 350 may produce a user interface 355 for user interaction therewith. The user interface 355 may be, for example, a “response room” for use with a specific project task.

The structured analysis tool 350 may identify the matter being worked on, either through automated review, or manual entry of an associated matter number. The structured analysis tool 350 may then scrape various sources of data, such as the docketing system 360, the file records 370, the file database 320, the electronic communication system 310, and combinations thereof. The structured analysis tool 350 may aggregate information and data relevant to the selected matter within the response room of the user interface 355.

The structured analysis tool 350 may then identify the specific task to be worked on relevant to the matter selected. For example, the structured analysis tool 350 may identify an office action response due for a pending patent matter. The structured analysis tool 350 may highlight or produce on the user interface 355 in the response room for the user any documents, data, and information relevant to the office action response. For example, the structured analysis tool 350 may indicate the due date of a response without extension, and the cost of extending the response deadline. The structured analysis tool 350 may indicate which claims were rejected, and under which statutes. The structured analysis tool 350 may indicated which claims were objected to. The structured analysis tool 350 may further indicate things like the need for a terminal disclaimer.

The structured analysis tool 350 may aggregate this information and produce one or more options for response, optionally producing templates associated with those responses. For example, if an office action response is desired that responds to a 112 rejection and a restriction requirement, the templates associated with the response may provide form text regarding the 112 rejection and restriction requirement elections. The structured analysis tool 350 may verify the appropriateness of the choice of templates as desired. Such templates, once verified, may be output to a user-editable format, such as a word document. In some cases, where the user selected a choice for response, the structured analysis tool 350 may further verify that this choice of response is feasible.

In another example, the structured analysis tool 350 may receive an indication of a new task to be worked on. In some cases, the structured analysis tool 350 may be automatically programmed to check on the state or status of a matter and/or related matters. For example, the workflow tool may receive an indication (automated or otherwise) to check on the state of a pending patent case and its child case.

The structured analysis tool 350 may collected current state data about the case and associated child case. Such state data may include, for example, whether the case is pending, if there is a first action in the case, if the case is allowed, if the case is rejected, if the case is objected to, details relating to rejections or objections, cited art listings, and more.

The structured analysis tool 350 may display the collected current state data on a user interface as desired. For example, requirements pending for the matter may be displayed, such as a need for formal drawings, a response to an examiner's rejection, a requirement for a formal assignment, or other requirements. In some cases, the structured analysis tool 350 may filter the requirements and display the relevant requirements, such as to the current actions not yet satisfied, on the user interface.

The structured analysis tool 350 may review the outstanding requirements for the case and display possible courses of action as a response to those requirements. For example, the structured analysis tool 350 may display on the user interface 355 optional courses of action such as file a response, file a petition, file a continuation, submit an RCE, or defer the action longer. These courses of action may be displayed, for example, relative to the requirements collected by the structured analysis tool 350.

Optionally, the structured analysis tool 350 may further display statistics related to each requirement and/or each potential course of action. For example, the structured analysis tool 350 may display a probability of success for a particular action based on historical data. In some cases, based on statistical analysis, the structured analysis tool 350 may suggest a course of action.

When the structured analysis tool 350 receives an indication of a selected course of action, the structured analysis tool 350 may produce, on the user interface 355, or in the associated response room, one or more templates or drafts associated with the selected course of action. For example, the structured analysis tool 350 may receive an indication that a terminal disclaimer is desired. In this case, the structured analysis tool 350 may push a draft shell for a terminal disclaimer to the user interface 355. Alternatively, the structured analysis tool 350 may use various templates to produce a document for editing by the user.

The structured analysis tool 350 may additionally push data to the response room on the user interface 355 that is bibliographic or informational for the user, such as the remaining potential term of a patent, patent publication, or pending application, based on its priority date. The structured analysis tool 350 may also provide alerts, or information about unexpected states, such as anomalies in priority claims, missing terminal disclaimers, or missing antecedent basis. Such alerts may be pushed to the user through the user interface 355.

The docketing system 360 may be an automated or semi-automated docketing system, such as the docketing system discussed above with reference to FIG. 1. The docketing system 360 may be in communication with the intake tool 330 and the splitting tool 350, and may receive documents, tasks, and communications with the intake tool 330. The docketing system may communicate with and update the file records 370.

The file records 370 may, for example, be a local or cloud-based file storage system including information of files and projects being worked on at or monitored by the company. The file records 370 may contain historical records, such as past events, communications, and decisions in each file.

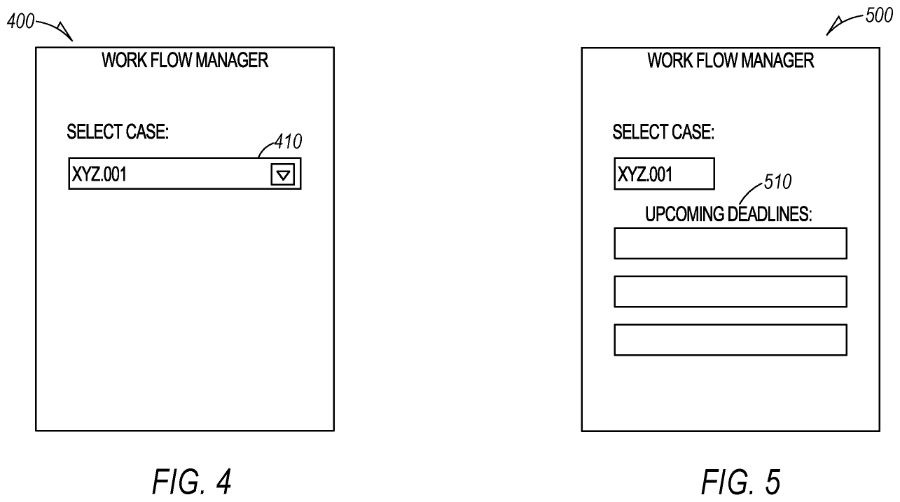

FIGS. 4-6 depict a schematic of a user interface for use with structured analysis tool in an example, and FIGS. 7-9 depict processes for using a response room and structured analysis tool.

FIG. 4 depicts a schematic of a user interface 400 for use with structured analysis tool in an example. The user interface 400 may be, for example, a user interface home page for the structured analysis tool. Here, a user may select the case to be worked on at menu 410. In some cases, the structured analysis tool may automatically scan and select a matter to be worked on.

FIG. 5 depicts a schematic of a user interface 500 for use with structured analysis tool in an example. At the user interface 500, the current state of the matter may be displayed. For example, upcoming deadlines 510 and tasks may be shown to the user. The user may, for example, select an upcoming deadline or task to work on.

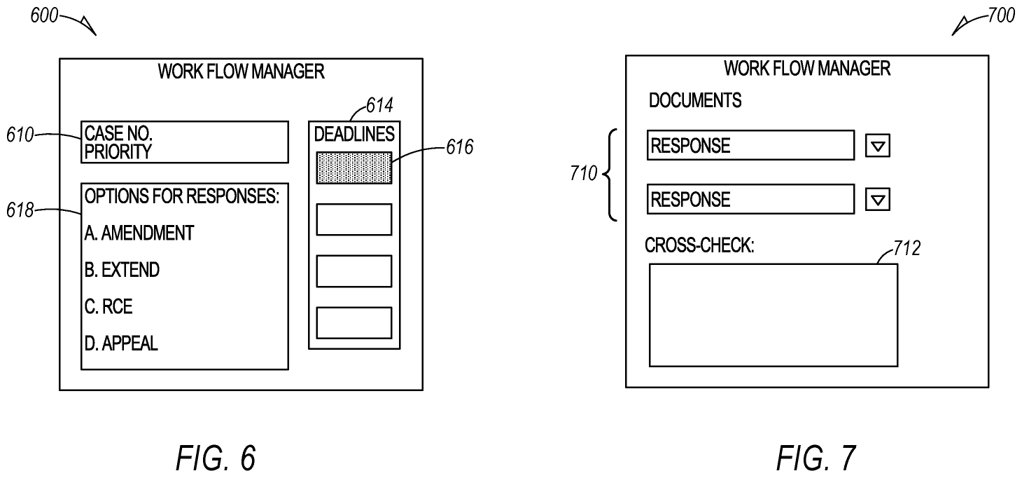

FIG. 6 depicts a schematic of a user interface 600 for use with structured analysis tool in an example. Here, the user interface 600 may display a work room or response room in which the user may see the data, documents, and information aggregated by the structured analysis tool. For example, the case bibliographic data 610 may be displayed. For example, the structured analysis tool may provide information regarding priority dates, pending family members, and other information useful to the user here. This section may optionally include alerts, such as for anomalies in the case, such as in priority claims, antecedent basis issues, or missing terminal disclaimers.

At the deadline box 614, the structured analysis tool may display aggregated information related to upcoming deadlines. These may be, for example, user-selectable. If deadline 616 is selected, for example, the structured analysis tool may then display options for response in the response box 618. The user may optionally select one of the options for response.

FIG. 7 depicts a schematic of a user interface 700 for use with structured analysis tool in an example. Here, a user has selected an option for response. At document section 710, the structured analysis tool may provide one or more documents, form text, or other useful items, for user use in proceeding with the selected option for response. At cross-check section 712, the structured analysis tool may provide any additional insights as desired, such as alerts provided by cross-checking the case.

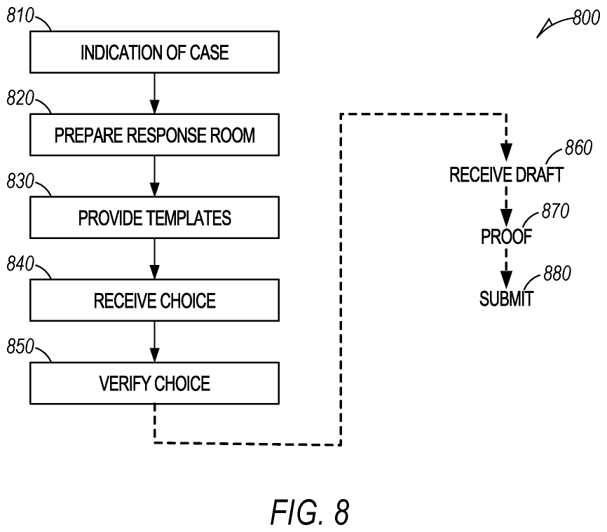

FIG. 8 depicts a process 800 of using a structured analysis tool in an example. The process 800 may include a structured analysis tool receiving an indication of a task to be worked on (step 810), preparing a response room (step 820), providing response templates to choose from (step 830), receiving a choice of a template (840), and verifying the appropriateness of the choice (step 850). Optionally, the structured analysis tool may further receive a drafted response in the template (step 860), proof the drafted response (step 870), and submit the drafted response (step 880).

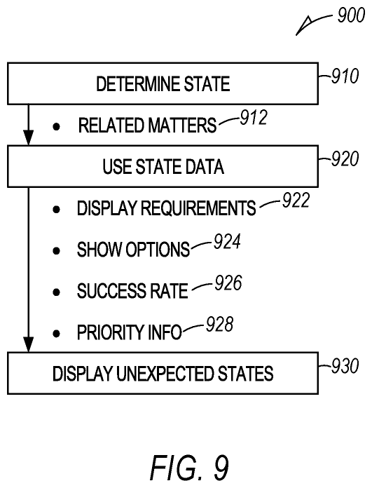

FIG. 9 depicts a process 900 of using a structured analysis tool in an example. Process 900 may include a structured analysis tool determining the current state of a matter (step 910) and any related matters (step 912). Then, the structured analysis tool may use state data (step 920) to determine and display requirements pending for the matter (step 922), possible courses of action (step 924), probabilities of success of each option or a recommendation of what to do (step 926), and the remaining term of a patent based on a priority date (step 928). Subsequently, the structured analysis tool may use the state data (step 930) to determine and display unexpected or suspect states.

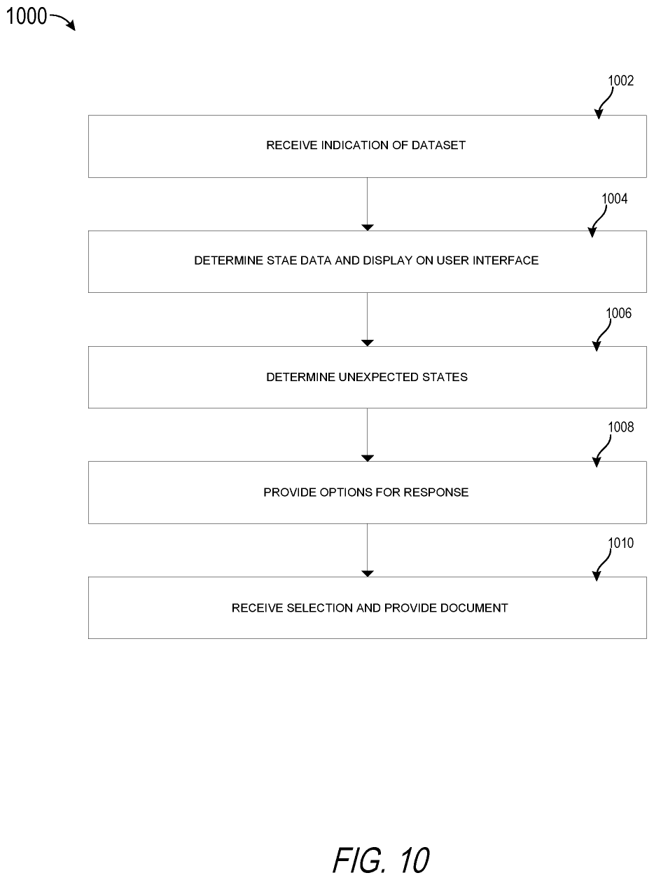

FIG. 10 depicts an example data display and recommendation method 1000.

At operation 1002, an indication of a dataset to be transformed may be received.

At operation 1004, state data contained in the dataset may be analyzed by the structured analysis tool to determine state data contained in the dataset. The dataset may represent one or more states of a process. Using the state data, a plurality of information may be displayed on a user interface.

At operation 1006, unexpected states of the process may be determined and displayed. Unexpected states of the process may comprise an anomaly with respect to various components of the dataset.

At operation 1008, one or more options for response based on the state data may be provided. A probability of success for each of the one or more options may be provided. A recommendation of which of the one or options to select may be provided. Pending requirements for the dataset, each of the one or more options for response correlating to one or more of the pending requirements, may be provided.

At operation 1010, a selection of the one or more options for response may be received, and a document for the response may be provided for user interaction.

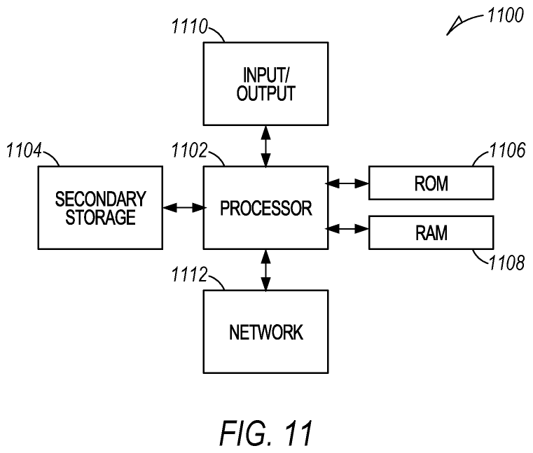

FIG. 11 is a block diagram of a typical, general-purpose computer 1100 that may be programmed into a special purpose computer suitable for implementing one or more embodiments of the manifest record generating program disclosed herein. The manifest record generating program described above may be implemented on any general-purpose processing component, such as a computer with sufficient processing power, memory resources, and communications throughput capability to handle the necessary workload placed upon it. The computer 1100 includes a processor 1102 (which may be referred to as a central processor unit or CPU) that is in communication with memory devices including secondary storage 1104, read only memory (ROM) 1106, random access memory (RANI) 1108, input/output (I/O) devices 1110, and network connectivity devices 1112. The processor 1102 may be implemented as one or more CPU chips or may be part of one or more application specific integrated circuits (ASICs).

The secondary storage 1104 is typically comprised of one or more disk drives or tape drives and is used for non-volatile storage of data and as an over-flow data storage device if RAM 1108 is not large enough to hold all working data. Secondary storage 1104 may be used to store programs that are loaded into RANI 1108 when such programs are selected for execution. The ROM 1106 is used to store instructions and perhaps data that are read during program execution. ROM 1106 is a non-volatile memory device that typically has a small memory capacity relative to the larger memory capacity of secondary storage 1104. The RAM 1108 is used to store volatile data and perhaps to store instructions. Access to both ROM 1106 and RAM 1108 is typically faster than to secondary storage 1104.

The devices described herein may be configured to include computer-readable non-transitory media storing computer-readable instructions and one or more processors coupled to the memory, and when executing the computer readable instructions configure the computer 1100 to perform method and process steps and operations described above with reference to FIG. 3 to FIG. 10. The computer-readable non-transitory media includes all types of computer-readable media, including magnetic storage media, optical storage media, flash media, and solid-state storage media.

It should be further understood that software including one or more computer-executable instructions that facilitate processing and operations as described above with reference to any one or all of steps of the disclosure may be installed in and sold with one or more servers and/or one or more routers and/or one or more devices within consumer and/or producer domains consistent with the disclosure. Alternatively, the software may be obtained and loaded into one or more servers and/or one or more routers and/or one or more devices within consumer and/or producer domains consistent with the disclosure, including obtaining the software through a physical medium or distribution system, including, for example, from a server owned by the software creator or from a server not owned but used by the software creator. The software may be stored on a server for distribution over the Internet, for example.

Also, it will be understood by one skilled in the art that this disclosure is not limited in its application to the details of construction and the arrangement of components set forth in the description or illustrated in the drawings. The embodiments herein are capable of other embodiments, and capable of being practiced or carried out in various ways. Also, it will be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected”, “coupled”, and “mounted”, and variations thereof herein are used broadly and encompass direct and indirect connections, couplings, and mountings. In addition, the terms “connected” and “coupled” and variations thereof are not restricted to physical or mechanical connections or couplings. Further, terms such as up, down, bottom, and top are relative, and are employed to aid illustration, but are not limiting.

The components of the illustrative devices, systems and methods employed in accordance with the illustrated embodiments may be implemented, at least in part, in digital electronic circuitry, analog electronic circuitry, or in computer hardware, firmware, software, or in combinations of them. These components may be implemented, for example, as a computing program product such as a computing program, program code or computer instructions tangibly embodied in an information carrier, or in a machine-readable storage device, for execution by, or to control the operation of, data processing apparatus such as a programmable processor, a computer, or multiple computers.

A computing program may be written in any form of programming language, including compiled or interpreted languages, and it may be deployed in any form, including as a stand-alone program or as a module, component, subroutine, or other unit suitable for use in a computing environment. A computing program may be deployed to be executed on one computer or on multiple computers at one site or distributed across multiple sites and interconnected by a communication network. Also, functional programs, codes, and code segments for accomplishing the techniques described herein may be easily construed as within the scope of the present disclosure by programmers skilled in the art. Method steps associated with the illustrative embodiments may be performed by one or more programmable processors executing a computing program, code or instructions to perform functions (e.g., by operating on input data and/or generating an output). Method steps may also be performed by, and apparatus may be implemented as, special purpose logic circuitry, e.g., an FPGA (field programmable gate array) or an ASIC (application-specific integrated circuit), for example.

The various illustrative logical blocks, modules, and circuits described in connection with the embodiments disclosed herein may be implemented or performed with a general-purpose processor, a digital signal processor (DSP), an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computing program include, by way of example, both general and special purpose microprocessors, and any one or more processors of any kind of digital computer. Generally, a processor will receive instructions and data from a read-only memory, a random-access memory, or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computing program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory may be supplemented by or incorporated in special purpose logic circuitry.

Those of skill in the art understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure. A software module may reside in random access memory (RAM), flash memory, ROM, EPROM, EEPROM, registers, hard disk, a removable disk, a CD-ROM, or any other form of storage medium known in the art. An exemplary storage medium is coupled to the processor such the processor may read information from, and write information to, the storage medium. In the alternative, the storage medium may be integral to the processor. In other words, the processor and the storage medium may reside in an integrated circuit or be implemented as discrete components.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory [EEPROM]), and/or any suitable combination thereof. The term “machine-readable medium” should be taken to include a single medium or multiple media (e.g., a centralized or distributed database, or associated caches and servers) able to store processor instructions. The term “machine-readable medium” shall also be taken to include any medium, or combination of multiple media, that is capable of storing instructions for execution by one or more processors, such that the instructions, when executed by one or more processors cause the one or more processors to perform any one or more of the methodologies described herein. Accordingly, a “machine-readable medium” refers to a single storage apparatus or device, as well as “cloud-based” storage systems or storage networks that include multiple storage apparatuses or devices. The term “machine-readable medium” as used herein excludes signals per se.

### VARIOUS NOTES & EXAMPLES

Example 1 is a computer implemented data display and recommendation method, the method comprising: receiving an indication of a dataset to be transformed; analyzing the dataset with a structured analysis tool to determine state data contained in the dataset, wherein the dataset represents one or more states of a process; using the determined state data of the dataset to display a plurality of information on a user interface related to the state data; determining and displaying one or more unexpected states of the process, wherein unexpected states comprise an anomaly with respect to various components of the dataset; providing one or more options for response based on the state data; providing a probability of success for each of the one or more options for response; providing a recommendation of which of the one or more options to select; providing one or more pending requirements for the dataset, each of the one or more options for response correlating to the one or more pending requirements; receiving an indication of a selection of the one or more options for response; and providing a document for the response for user interaction.

In Example 2, the subject matter of Example 1 optionally includes wherein the state data comprises an indication of pending, no first action, rejected, allowed, objected to, or combinations thereof.

In Example 3, the subject matter of any one or more of Examples 1-2 optionally includes wherein the state data includes details of each of the one or more states of the process.

In Example 4, the subject matter of any one or more of Examples 1-3 optionally includes wherein providing one or more options comprises providing a choice for the user to file a response, to file an amendment, to file a petition, to file a continuation, to file a divisional, to file a request for continued examinations, to file an appeal, to file a communication, to extend, to defer, or combinations thereof.

In Example 5, the subject matter of any one or more of Examples 1-4 optionally includes wherein the requirements comprises one or more of formal drawings, response to rejections, formal documents, or combinations thereof.

In Example 6, the subject matter of any one or more of Examples 1-5 optionally further comprises providing information regarding a remaining patent term.

In Example 7, the subject matter of any one or more of Examples 1-6 optionally further comprises receiving the indication of the dataset to be transformed; preparing a response room user interface comprising data related to the dataset; proposing one or more templates for use within the response room, each of the one or more templates related to an action required in the dataset; receiving a selection of a template from the one or more templates; verifying the selection of the template and making suggestions based on the selection; receiving a completed template from a user, and cross-checking the completed template; and proofing the completed template.

In Example 8, the subject matter of Examples 1-7 optionally further comprises receiving a document in a response room, the document prepared for filing with a governmental entity; analyzing the document with a structured analysis tool to determine one or more parameters associated with the document; choosing a standard response template based on the one or more parameters associated with the document, wherein the standard response template includes a plurality of requirements for filing the document with the governmental entity; verifying, using the standard response template, that the document fulfills the plurality of requirements; and displaying a report, on a user interface, indicating if one or more of the plurality of requirements are not met.

In Example 9, the subject matter of any one or more of Examples 1-8 optionally includes wherein the governmental entity is the U.S. Patent and Trademark Office.

In Example 10, the subject matter of any one or more of Examples 1-9 optionally includes wherein the plurality of requirements includes one or more of formatting and content requirements.

Example 11 is a data display and recommendation system, the system comprising: a memory that stores instructions for implementing a structured analysis tool; and one or more processors that execute the instructions for the structured analysis tool to perform operations including: receiving an indication of a dataset to be transformed; analyzing the dataset with the structured analysis tool to determine state data contained in the dataset, wherein the dataset represents one or more states of a process; using the determined state data of the dataset to display a plurality of information on a user interface related to the state data; determining and displaying one or more unexpected states of the process, wherein unexpected states comprise an anomaly with respect to various components of the dataset; providing one or more options for response based on the analyzed state data; providing a probability of success for each of the one or more options for response; providing a recommendation of which of the one or more options to select; providing one or more pending requirements for the dataset, each of the one or more options for response correlating to the one or more pending requirements; and receiving an indication of a selection of the one or more options for response, and; providing a document for the response for user interaction.

In Example 12, the subject matter of Example 11 optionally further comprises receiving the indication of the dataset to be transformed; preparing a response room user interface comprising data related to the dataset; proposing one or more templates for use within the response room, each of the one or more templates related to an action required in the dataset; receiving a selection of a template from the one or more templates; verifying the selection of the template and making suggestions based on the selection; receiving a completed template from a user, and cross-checking the completed template, and; proofing the completed template.

In Example 13 the subject matter of any one or more of Examples 11-12 optionally further comprises receiving a document in a response room, the document prepared for filing with a governmental entity; analyzing the document with the structured analysis tool to determine one or more parameters associated with the document; choosing a standard response template based on the one or more parameters associated with the document, wherein the standard response template includes a plurality of requirements for filing the document with the governmental entity; verifying, using the standard response template, that the document fulfills the plurality of requirements, and; displaying a report, on a user interface, indicating if one or more of the plurality of requirements are not met.

In Example 14, the subject matter of any one or more of Examples 11-13 optionally further comprises providing information regarding a remaining patent term.

In Example 15, the subject matter of any one or more of Examples 11-14 optionally includes wherein providing one or more options comprises providing a choice for the user to file a response, to file an amendment, to file a petition, to file a continuation, to file a divisional, to file a request for continued examination, to file an appeal, to file a communication, to extend, to defer, or combinations thereof.

In Example 16, the subject matter of any one or more of Examples 11-15 optionally includes wherein the pending requirements comprises one or more of formal drawings, response to rejections, formal documents, or combinations thereof.

In Example 17, the subject matter of any one or more of Examples 11-16 optionally includes wherein the state data comprises an indication of pending, no first action, rejected, allowed, objected to, or combinations thereof.

In Example 18, the subject matter of any one of Examples 11-17 optionally includes wherein the state data includes details of each of the states of the process.

In Example 19, the subject matter of any one of Examples 11-18 optionally includes wherein the plurality of requirements includes one or more of formatting and content requirements.

In Example 20, the subject matter of any one of Examples 11-19 optionally includes wherein the governmental entity is the U.S. Patent and Trademark Office.

Each of these non-limiting examples may stand on its own or may be combined in various permutations or combinations with one or more of the other examples.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer-readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

What is claimed is:

1. A computer implemented data display and recommendation method comprising:
receiving an indication of a dataset to be transformed;
analyzing the dataset with a structured analysis tool to determine state data contained in the dataset, wherein the dataset represents one or more states of a process;
using the determined state data of the dataset to display a plurality of information on a user interface related to the state data;
determining and displaying one or more unexpected states of the process, wherein unexpected states comprise an anomaly with respect to various components of the dataset;
providing one or more options for response based on the state data;
providing a probability of success for each of the one or more options for response;
providing a recommendation of which of the one or more options to select;
providing one or more pending requirements for the dataset, each of the one or more options for response correlating to the one or more pending requirements;
receiving an indication of a selection of the one or more options for response; and
providing a document for the response for user interaction.

2. The method of claim 1, wherein the state data comprises an indication of pending, no first action, rejected, allowed, objected to, or combinations thereof.

3. The method of claim 2, wherein the state data includes details of each of the one or more states of the process.

4. The method of claim 1, wherein providing one or more options for response comprises providing a choice for a user to file a response, to file an amendment, to file a petition, to file a continuation, to file a divisional, to file a request for continued examination, to file an appeal, to file a communication, to extend, to defer, or combinations thereof.

5. The method of claim 1, wherein the one or more pending requirements for the dataset comprises one or more of formal drawings, response to rejections, formal documents, or combinations thereof.

6. The method of claim 1, further comprising providing information regarding a remaining patent term.

7. The method of claim 1, further comprising:
receiving the indication of the dataset to be transformed;
preparing a response room user interface comprising data related to the dataset;
proposing one or more templates for use within the response room, each of the one or more templates related to an action required in the dataset;
receiving a selection of a template from the one or more templates;
verifying the selection of the template and making suggestions based on the selection;
receiving a completed template from a user, and cross-checking the completed template; and
proofing the completed template.

8. The method of claim 1, further comprising:
receiving a document in a response room, the document prepared for filing with a governmental entity;
analyzing the document with a structured analysis tool to determine one or more parameters associated with the document;
choosing a standard response template based on the one or more parameters associated with the document, wherein the standard response template includes a plurality of requirements for filing the document with the governmental entity;
verifying, using the standard response template, that the document fulfills the plurality of requirements; and
displaying a report, on a user interface, indicating if one or more of the plurality of requirements are not met.

9. The method of claim 8, wherein the governmental entity is the U.S. Patent and Trademark Office.

10. The method of claim 8, wherein the plurality of requirements includes one or more of formatting and content requirements.

11. A data display and recommendation system, the system comprising:
a memory that stores instructions for implementing a structured analysis tool; and one or more processors that execute the instructions for the structured analysis tool to perform operations including:
receiving an indication of a dataset to be transformed;
analyzing the dataset with the structured analysis tool to determine state data contained in the dataset, wherein the dataset represents one or more states of a process;
using the determined state data of the dataset to display a plurality of information on a user interface related to the state data;
determining and displaying one or more unexpected states of the process, wherein unexpected states comprise an anomaly with respect to various components of the dataset;
providing one or more options for response based on the analyzed state data;
providing a probability of success for each of the one or more options for response;
providing a recommendation of which of the one or more options to select;
providing one or more pending requirements for the dataset, each of the one or more options for response correlating to the one or more pending requirements, and;
receiving an indication of a selection of the one or more options for response; and
providing a document for the response for user interaction.

12. The system of claim 11, further comprising:
receiving the indication of the dataset to be transformed;
preparing a response room user interface comprising data related to the dataset;
proposing one or more templates for use within the response room, each of the one or more templates related to an action required in the dataset;
receiving a selection of a template from the one or more templates;
verifying the selection of the template and making suggestions based on the selection;
receiving a completed template from a user, and cross-checking the completed template, and;
proofing the completed template.

13. The system of claim 12, further comprising:
receiving a document in a response room, the document prepared for filing with a governmental entity;
analyzing the document with the structured analysis tool to determine one or more parameters associated with the document;
choosing a standard response template based on the one or more parameters associated with the document, using the structured analysis tool, wherein the standard response template includes a plurality of requirements for filing the document with the governmental entity;
verifying, using the standard response template, that the document fulfills the plurality of requirements, using the structured analysis tool, and;
displaying a report, on a user interface, indicating if one or more of the plurality of requirements are not met.

14. The system of claim 11, further comprising providing information regarding a remaining patent term.

15. The system of claim 11, wherein providing one or more options comprises providing a choice for the user to file a response, to file an amendment, to file a petition, to file a continuation, to file a divisional, to file a request for continued examination, to file an appeal, to file a communication, to extend, to defer, or combinations thereof.

16. The system of claim 11, wherein the pending requirements comprises one or more of formal drawings, response to rejections, formal documents, or combinations thereof.

17. The system of claim 11, wherein the state data comprises an indication of pending, no first action, rejected, allowed, objected to, or combinations thereof.

18. The system of claim 17, wherein the state data includes details of each of the states of the process.

19. The system of claim 13, wherein the plurality of requirements includes one or more of formatting and content requirements.

20. The system of claim 13, wherein the governmental entity is the U.S. Patent and Trademark Office.
